(19) United States
(12) Patent Application Publication
(10) Pub. No.: US 2021/0195323 A1
(43) Pub. Date: Jun. 24, 2021

(54) CABLE APPARATUS, NOISE CANCELLING APPARATUS, AND NOISE CANCELLING METHOD

(71) Applicant: SONY CORPORATION, TOKYO (JP)

(72) Inventor: MASAAKI OSHIKATA, TOKYO (JP)

(21) Appl. No.: 17/056,498

(22) PCT Filed: May 9, 2019
(86) PCT No.: PCT/JP2019/018483

§ 371 Date: Nov. 18, 2020

(30) Foreign Application Priority Data
May 23, 2018 (JP) 2018-098494

(51) Int. Cl. H04R 3/00; H04B 3/26; H04R 3/04

(52) U.S. Cl. CPC H04R 3/007; H04R 3/04; H04B 3/26

(57) ABSTRACT

The present technique relates to a cable apparatus, a noise canceling apparatus, and a noise canceling method that allow reliable removal of noise induced by a radio wave. A cable apparatus is provided with wiring for input which is electrically connected to a device and through which an input signal and an RF noise signal induced are transmitted, and wiring for noise detection which is electrically connected to an adjustment element enabled to be adjusted to an impedance corresponding to an input impedance of an output circuit of the device and in which the RF noise signal is induced. Thus, noise included in a signal from the first wiring can be reliably removed. The present technique can be applied to a noise canceling system, for example.

### TECHNICAL FIELD

The present technique relates to a cable apparatus, a noise canceling apparatus, and a noise canceling method, and in particular, to a cable apparatus, a noise canceling apparatus, and a noise canceling method enabled to reliably remove noise induced by a radio wave.

### BACKGROUND ART

In recent years, IoT (Internet of Things) has been remarkably developed, and various types of wireless communication functions are provided in every IoT device from various products to infrastructure equipment. These IoT devices generally have a function of loading information (analog information) from an outside world and outputting the information. In other words, the IoT device is generally assumed to deal with every signal from high-frequency radio signals to low-frequency analog signals. Here, analog signals generally have low noise immunity, and thus, noise induced by a radio wave is non-negligible.

For example, PTL 1 discloses a technique in which, in addition to a first microphone acquiring voice emitted by a speaker, a second microphone acquiring noise is provided to remove a noise signal acquired by the second microphone from a voice signal acquired by the first microphone.

### CITATION LIST

### Patent Literature

[PTL 1]

JP 2009-188858 A

### SUMMARY

### Technical Problem

However, the technique disclosed in PTL 1 described above cannot remove noise induced by the radio wave and is thus far from taking sufficient countermeasures for preventing noise.

In view of these circumstances, an object of the present technique is to allow reliable removal of the noise induced by the radio wave.

### Solution to Problem

A cable apparatus according to a first aspect of the present technique is a cable apparatus including wiring for input which is electrically connected to a device and through which an input signal and an RF noise signal induced are transmitted, and wiring for noise detection which is electrically connected to an adjustment element enabled to be adjusted to an impedance corresponding to an input impedance of an output circuit of the device and in which the RF noise signal is induced.

The cable apparatus according to the first aspect of the present technique is provided with the wiring for input which is electrically connected to the device and through which the input signal and the RF noise signal induced are transmitted and the wiring for noise detection which is electrically connected to the adjustment element enabled to be adjusted to the impedance corresponding to the input impedance of the output circuit of the device and in which the RF noise signal is induced.

A noise canceling apparatus according to a second aspect of the present technique is a noise canceling apparatus including a signal processing section configured to remove a noise signal to an input signal transmitted through wiring for input electrically connected to a device, using an RF noise signal induced in wiring for noise detection electrically connected to an adjustment element enabled to be adjusted to an impedance corresponding to an input impedance of an output circuit of the device.

A noise canceling method according to the second aspect of the present technique is a noise canceling method corresponding to the noise canceling apparatus according to the second aspect of the present technique described above.

In the noise canceling apparatus and the noise canceling method according to the second aspect of the present technique, the RF noise signal to the input signal transmitted through the wiring for input electrically connected to the device is removed using the RF noise signal induced in the wiring for noise detection electrically connected to the adjustment element enabled to be adjusted to the impedance corresponding to the input impedance of the output circuit of the device.

The cable apparatus according to the first aspect of the present technique and the noise canceling apparatus according to the second aspect of the present technique may be independent apparatuses or internal blocks forming one apparatus.

### Advantageous Effect of Invention

According to the first aspect and the second aspect of the present technique, noise induced by a radio wave can be reliably removed.

Note that the effects described here are not necessarily limited and that any of the effects described in the present disclosure may be produced.

### BRIEF DESCRIPTION OF DRAWINGS

FIG. 1 is a diagram illustrating the principle of generation of radio wave noise.

FIG. 2 is a diagram illustrating an example of a configuration of a general noise canceling system.

FIG. 3 is a diagram illustrating a configuration example of an embodiment of a noise canceling system to which the present technique is applied.

FIG. 4 is a diagram illustrating a first example of a configuration of the noise canceling system to which the present technique is applied.

FIG. 5 is a diagram illustrating a second example of a configuration of the noise canceling system to which the present technique is applied.

FIG. 6 is a diagram illustrating a third example of a configuration of the noise canceling system to which the present technique is applied.

FIG. 7 is a diagram illustrating a fourth example of a configuration of a noise canceling system to which the present technique is applied.

FIG. 8 is a diagram illustrating an example of a configuration of a computer.

FIG. 9 is a view depicting an example of a schematic configuration of an endoscopic surgery system.

FIG. 10 is a block diagram depicting an example of a functional configuration of a camera head and a camera control unit (CCU) depicted in FIG. 9.

### DESCRIPTION OF EMBODIMENT

An embodiment of the present technique will be described with reference to the drawings. Note that the description will be in the following order.
1. Embodiment of Present Technique
2. Modified Example
3. Configuration of Computer
4. Applied Example

### <1. Embodiment of Present Technique>

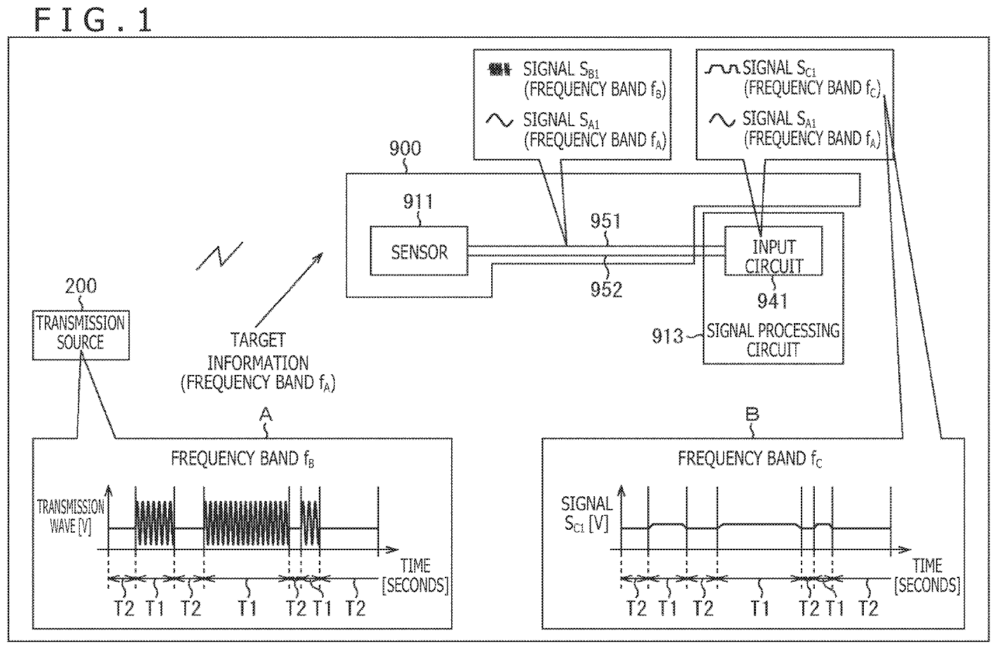

FIG. 1 is a diagram illustrating the principle of generation of radio noise.

In FIG. 1, a noise canceling system includes a sensor 911, a signal processing circuit 913 including an input circuit 941, and a signal line 951 and a ground line 952 through which electric signals from the sensor 911 are transmitted to (the input circuit 941 of) the signal processing circuit 913.

The sensor 911 is adjusted to a frequency band f_{A} for target information (desired information) and can detect the target information. Additionally, here, the sensor 911, the signal line 951, and the ground line 952 form a circuit network 900.

In a case where such a configuration is employed, the circuit network 900 behaves like an antenna for a frequency band f_{B} corresponding to a frequency band higher than the frequency band f_{A}. Specifically, as illustrated in FIG. 1, in a case where a transmission source 200 for radio waves that performs wireless communication using the frequency band f_{B} is present near the circuit network 900, the circuit network 900 induces a signal S_{B1} in addition to a signal S_{A1} corresponding to the target information.

Here, as illustrated at a portion A in FIG. 1, in the wireless communication (frequency band f_{B}) performed by the transmission source 200, a first period T1 during which a radio wave is transmitted and a second period T2 during which no radio wave is transmitted are repeatedly present in a time domain in accordance with a predetermined communication scheme. Thus, in the signal line 951 and the ground line 952, the first period T1, during which the signal S_{B1} is generated that is induced by the wireless communication performed by the transmission source 200, and the second period T2, during which the signal S_{B1} is not generated, are repeatedly present in the time domain.

Additionally, in the signal processing circuit 913, input characteristics of the input circuit 941 are not completely linear, and thus, the signal obtained by the input circuit 941 has a difference in DC level between the first period T1 and the second period T2. The frequency characteristic of a signal S_{C1} resulting from repetition of the first period T1 and the second period T2 corresponds to a frequency band f_{C} (for example, a portion B in FIG. 1) lower than the frequency band f_{B}.

Depending on the combination of the first period T1 and the second period T2, the frequency band f_{C} is included in the frequency band f_{A}. In a case where the frequency band f_{C} is included in the frequency band f_{A}, the signal S_{C1}, including unnecessary information, is superimposed on the signal S_{A1} corresponding to the target information, causing the signal S_{C1} to appear as noise.

As a countermeasure against such noise, it is assumed that a filter for reducing the frequency band f_{B} (for example, a low pass filter or the like) is provided between the circuit network 900 and the input circuit 941 of the signal processing circuit 913, thereby reducing the signal S_{C1}.

However, in a case where a configuration provided with such a filter is employed, the input circuit 941 is generally equipped with an amplifier for amplifying the signal S_{A1} subjected to a conversion by the sensor 911, and thus, the signal S_{C1} in the frequency band f_{C} included in the frequency band f_{A} is amplified by the amplifier, similarly to the signal S_{A1}. Thus, the filter is required to provide a very large amount of attenuation.

Additionally, the intensity of the signal S_{C1} to be removed varies significantly depending on a positional relation between the circuit network 900 and the transmission source 200 for radio waves that performs wireless communication, the radio field intensity of the wireless communication, and the like, and thus, when the filter is set, the required amount of attenuation cannot be clearly defined.

As described above, a configuration with the filter interposed between the circuit network 900 and the input circuit 941 of the signal processing circuit 913 is insufficient to serve as the countermeasure against noise.

Additionally, PTL 1 described above discloses a configuration which is provided with a second microphone acquiring noise in addition to a first microphone acquiring voice emitted by a speaker and in which a noise signal acquired by the second microphone is removed from a voice signal acquired by the first microphone.

Specifically, this noise cancelation technique removes a signal S_{A2} (noise) obtained by a second sensor (second microphone) from a signal S_{A1} (signal+noise) obtained by a first sensor (first microphone). Additionally, here, as the first sensor (first microphone) and the second sensor (second microphone), sensors (microphones) dealing with the same frequency (frequency band f_{A}) are used.

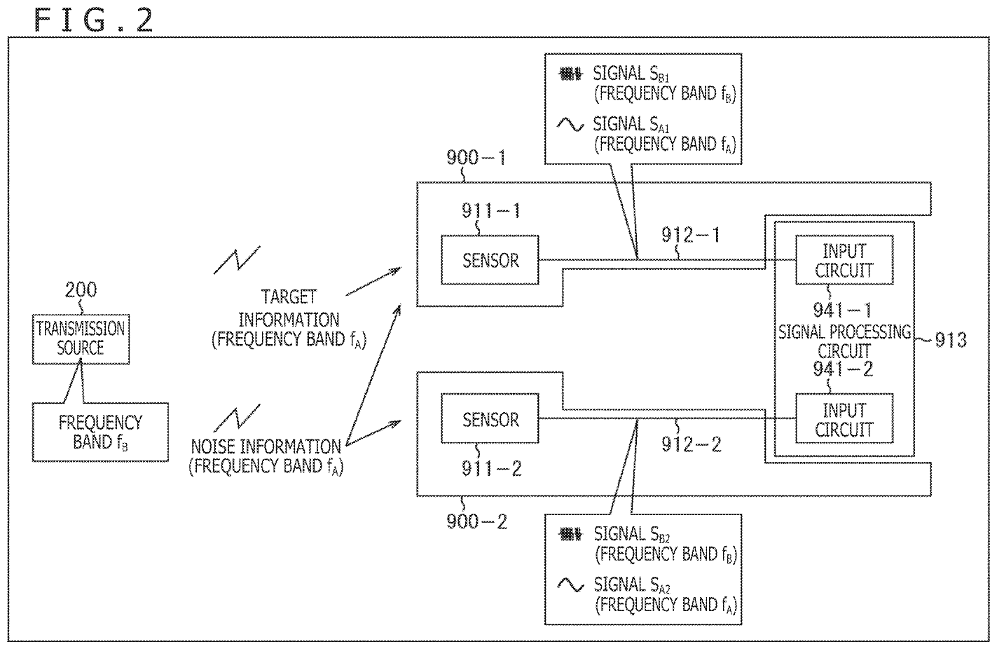

Meanwhile, as illustrated in FIG. 2, in a case where the configuration illustrated in FIG. 1 is applied to the configuration disclosed in PTL 1, the signal S_{B1} and a signal S_{B2} induced by the transmission source 200 (frequency band f_{B}) described above are phenomena resulting from the behavior, as antennas, of a circuit network 900-1 corresponding to a system including a sensor 911-1 and wiring 912-1 and a circuit network 900-2 corresponding to a system including a sensor 911-2 and wiring 912-2.

The signal S_{B1} and the signal S_{B2} resulting from such phenomena are not referred to in PTL 1, and furthermore, the configuration disclosed in PTL 1 fails to exclusively remove the signal S_{B1} superimposed on the signal S_{A1}.

Note that, as a countermeasure against the behavior of the circuit network 900 as an antenna, also assumed is a method in which the signal line 951 and the ground line 952 in the circuit network 900 have a twisted pair structure to reduce the efficiency of the frequency band f_{B} when the circuit network 900 behaves as an antenna. Here, the twisted pair structure is a structure including two signal lines twisted into a pair and having a feature of being less susceptible to noise than simple parallel lines.

However, in the circuit network 900, in a case where the signal line 951 and the ground line 952 have a twisted pair structure, the frequency characteristic resulting from the behavior of the circuit network 900 as an antenna is varied by a peripheral structure of the signal line 951 and the ground line 952 (for example, in a case where a metal or the like approaches), leading to a wiring constraint. Thus, the employment of the twisted pair structure is insufficient to serve as a countermeasure against noise induced by a radio wave.

Since the countermeasure against noise resulting from the behavior of the circuit network as an antenna is insufficient as described above, a technique for reliably removing the noise induced by the radio wave has been desired. In view of this, in the present technique (technique according to the present disclosure), an adjustment element designed under predetermined conditions for the circuit network is provided to allow reliable removal of noise resulting from the behavior of the circuit network as an antenna. An embodiment of the present technique will be described. In the following description, the noise is assumed to include, for example, RF noise, interference, and the like.

### (Configuration of Present Technique)

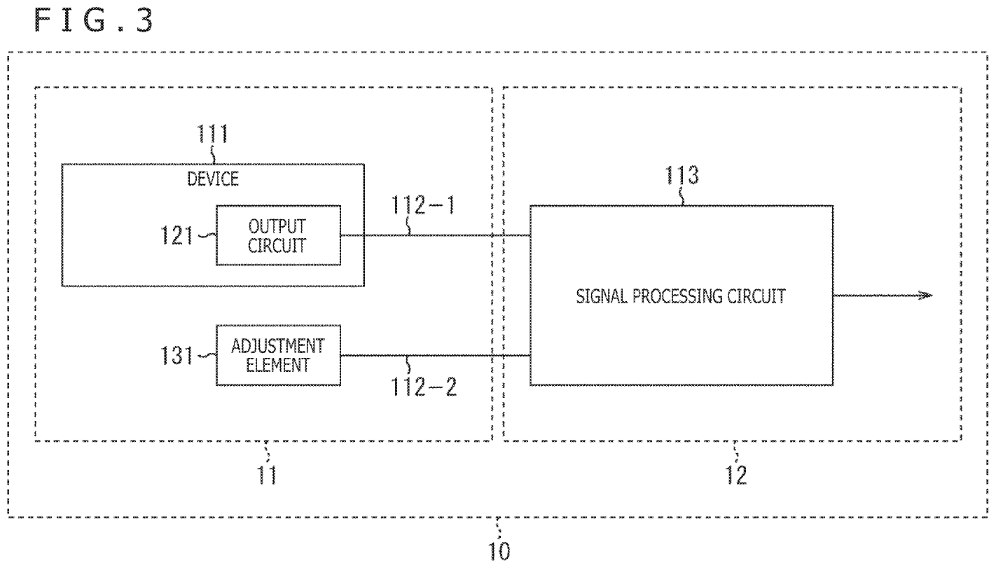

FIG. 3 is a diagram illustrating an example of a configuration of an embodiment of a noise canceling system to which the present technique is applied.

In FIG. 3, a noise canceling system 10 includes a cable apparatus 11 and a noise canceling apparatus 12.

The cable apparatus 11 includes a device 111, wiring 112-1 electrically connected to the device 111, and wiring 112-2 electrically connected to an adjustment element 131.

The device 111 is configured as a sensor, an output apparatus outputting analog signals, or the like, for example. The device 111 includes an output circuit 121. The output circuit 121 is electrically connected to the wiring 112-1.

The adjustment element 131 can adjust to an impedance corresponding to an input impedance of the output circuit 121 of the device 111 and is electrically connected to the wiring 112-2. The adjustment element 131 includes at least one of, for example, a fixed resistor, a capacitor, or an inductor.

The noise canceling apparatus 12 includes a signal processing circuit 113.

The signal processing circuit 113 includes, for example, a processor such as a microprocessor. The signal processing circuit 113 is electrically connected to each of the wiring 112-1 and the wiring 112-2 of the cable apparatus 11. The signal processing circuit 113 uses a signal from the wiring 112-2 to remove (cancel) noise included in a signal from the wiring 112-1 and outputs the resultant signal to a succeeding circuit (not illustrated).

Note that the configuration illustrated in FIG. 3 is an example and that the signal processing circuit 113 may be included on the cable apparatus 11 side or that the device 111 and the wiring 112-1, and the adjustment element 131 and the wiring 112-2 may be included on the noise canceling apparatus 12 side. Furthermore, for example, the device 111 and the adjustment element 131 may be omitted from the cable apparatus 11, in other words, the wiring 112-1 and the wiring 112-2 may form the cable apparatus 11.

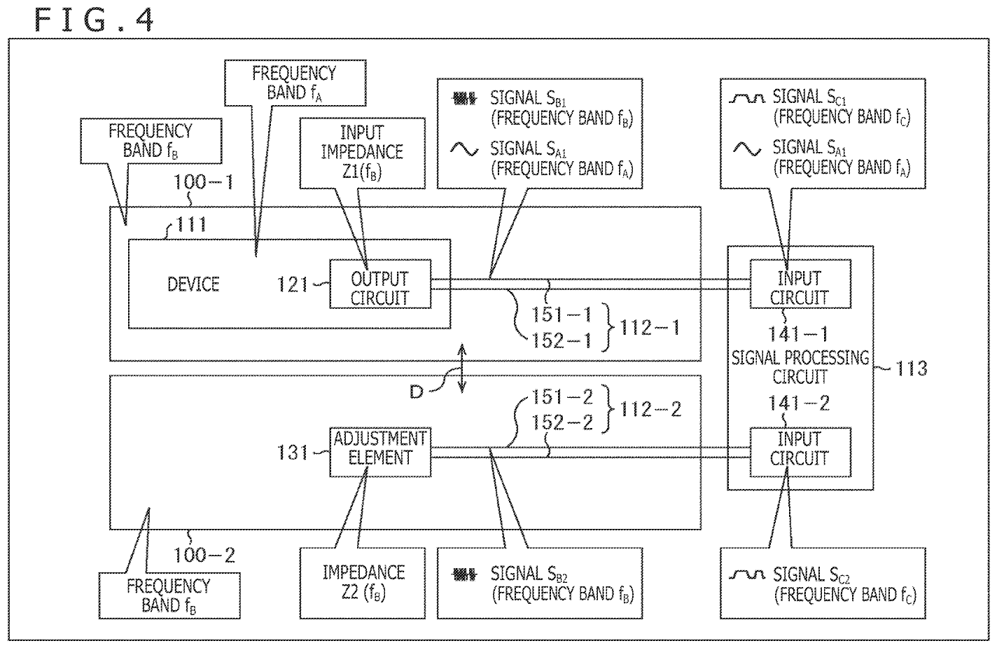

The noise canceling system 10 configured as described above is provided with the adjustment element 131 designed under the predetermined conditions for the circuit network, to remove noise resulting from the behavior of the circuit network as an antenna. Now, a detailed configuration of the noise canceling system 10 will be described with reference to FIGS. 4 to 7.

### (First Example of Configuration of Present Technique)

FIG. 4 is a diagram illustrating a first example of a configuration of the noise canceling system to which the present technique is applied.

In FIG. 4, the noise canceling system 10 includes the device 111, the wiring 112-1, the wiring 112-2, the signal processing circuit 113, and the adjustment element 131.

The device 111 includes the output circuit 121. The signal processing circuit 113 includes an input circuit 141-1 and an input circuit 141-2. Additionally, the wiring 112-1 includes a signal line 151-1 and a ground line 152-1, and the wiring 112-2 includes a signal line 151-2 and a ground line 152-2.

The (output circuit 121 of the) device 111 is connected to (the input circuit 141-1 of) the signal processing circuit 113 via the wiring 112-1. The adjustment element 131 is connected to the (input circuit 141-2 of the) signal processing circuit 113 via the wiring 112-2.

Additionally, in the noise canceling system 10, the device 111 and the wiring 112-1 form a circuit network 100-1, and the adjustment element 131 and the wiring 112-2 form a circuit network 100-2.

The device 111 is an apparatus that is adjusted to the frequency band f_{A} for target information and that processes a signal corresponding to the target information and outputs the processed signal. The device 111 can include, for example, any of various sensor devices, a circuit outputting analog signals (analog output circuit), or the like.

The adjustment element 131 is an element for acquiring noise resulting from a radio wave transmitted by wireless communication (frequency band f_{B}) performed by the transmission source 200. Here, the adjustment element 131 is designed to output no signals in the frequency band f_{A} corresponding to an output from the (output circuit 121 of the) device 111 and to have, for the frequency band f_{B}, electrical characteristics corresponding to the device 111.

For example, in a case where the device 111 is a microphone dealing with a voice band and assumed wireless communication is in a 2.4-GHz band, the adjustment element 131 is configured using an element such as a fixed resistor, a capacitor, or an inductor such that the voice band is not converted into an electric signal and that, in the 2.4-GHz band, the adjustment element 131 has electrical characteristics similar to those of the microphone.

Specifically, an equivalent circuit having an impedance Z2 (frequency band f_{B}) corresponding to an input impedance Z1 (frequency band f_{B}) of the output circuit 121 of the device 111 is configured as the adjustment element 131 in such a manner as to provide the circuit network 100-1 and the circuit network 100-2 with similar frequency characteristics (the same frequency characteristic or corresponding frequency characteristics) with respect to the frequency band f_{B}, as viewed from the succeeding signal processing circuit 113.

Note that, in FIG. 4, the circuit network 100-1 and the circuit network 100-2 are assumed to lie within the reachable range of a radio wave to be transmitted by the wireless communication (frequency band f_{B}) performed by the transmission source 200.

In a case where the circuit network 100-1 including the device 111 outputting the signal S_{A1} (frequency band f_{A}) corresponding to the target information and the circuit network 100-2 including the adjustment element 131 for acquiring noise are designed to have similar frequency characteristics when the circuit networks behave as antennas in the frequency band f_{B}, as described above, a signal to be output from the adjustment element 131 corresponds to noise generated by the wireless communication and does not contain the signal S_{A1} in the frequency band f_{A}.

In other words, in the noise canceling system 10, the wiring 112-1 included in the circuit network 100-1 is used as wiring for input through which an input signal and induced RF noise are transmitted, whereas the wiring 112-2 included in the circuit network 100-2 is used as wiring for noise detection in which RF noise is induced.

The signal processing circuit 113 is a circuit executing signal processing for removing noise. The signal processing circuit 113 includes the input circuit 141-1 and the input circuit 141-2.

In a case where the input circuit 141-1 is connected to the wiring 112-1 and lies within the reachable range of a radio wave from the transmission source 200, a signal including the signal S_{C1} superimposed on the signal S_{A1} is input to the input circuit 141-1. Additionally, in a case where the input circuit 141-2 is connected to the wiring 112-2 and lies within the reachable range of a radio wave from the transmission source 200, a signal S_{C2} is input to the input circuit 141-2.

The signal processing circuit 113 can acquire the signal S_{A1} corresponding to the target information by using the signal S_{C2} obtained by the input circuit 141-2 to remove the signal S_{C1} superimposed on the signal S_{A1} obtained by the input circuit 141-1.

Specifically, as described in the principle above, in accordance with the predetermined communication scheme, the first period T1 during which radio waves are transmitted and the second period T2 during which no radio wave is transmitted are repeatedly present in the time domain. Additionally, the frequency characteristic of the signal S_{C1} resulting from the repetition of the first period T1 and the second period T2 corresponds to the frequency band f_{C}, which is lower than the frequency band f_{B}, and depending on the combination of the first period T1 and the second period T2, the frequency band f_{C} is included in the frequency band f_{A}.

In the input circuit 141-1 connected to the wiring 112-1, in a case where the frequency band f_{C} is included in the frequency band f_{A}, the signal S_{C1}, including unnecessary information, is superimposed on the signal S_{A1} corresponding to the target information, and as a result, the resultant signal appears as noise. In contrast, the input circuit 141-2 connected to the wiring 112-2 obtains the signal S_{C2} corresponding to the noise, and thus, the signal processing circuit 113 can remove the signal S_{C1} superimposed on the signal S_{A1} from the wiring 112-1, by using the signal S_{C2} from the wiring 112-2.

Note that the signal induced by the wireless communication (the amount of noise) varies depending on the transmission source 200 of radio wave and the positional relation between the circuit network 100-1 and the circuit network 100-2, and thus, (the wiring 112-1 in) the circuit network 100-1 and (the wiring 112-2 in) the circuit network 100-2 are desirably disposed in proximity to each other (arrow D in the figure) such that the signal S_{C1} from the wiring 112-1 becomes equivalent to the signal S_{C2} from the wiring 112-2.

In this case, for example, the wiring 112-1 and the wiring 112-2 can be combined into one cable. Additionally, for example, the wiring 112-1 and the wiring 112-2 may be disposed parallel to each other. Furthermore, preferably, the wiring 112-1 and the wiring 112-2 have corresponding structures, for example, have substantially the same length and substantially the same characteristics.

Additionally, in the frequency band f_{B}, a difference in characteristics between the input impedance Z1 of the (output circuit 121 of the) device 111 and the impedance Z2 configured by the adjustment element 131 can be absorbed by parameters processed by the signal processing circuit 113. Similarly, a difference in characteristics between the input circuit 141-1 and the input circuit 141-2 and a difference in arrangement between the circuit network 100-1 and the circuit network 100-2 can also be absorbed by the parameters of the signal processing circuit 113.

### (Second Example of Configuration of Present Technique)

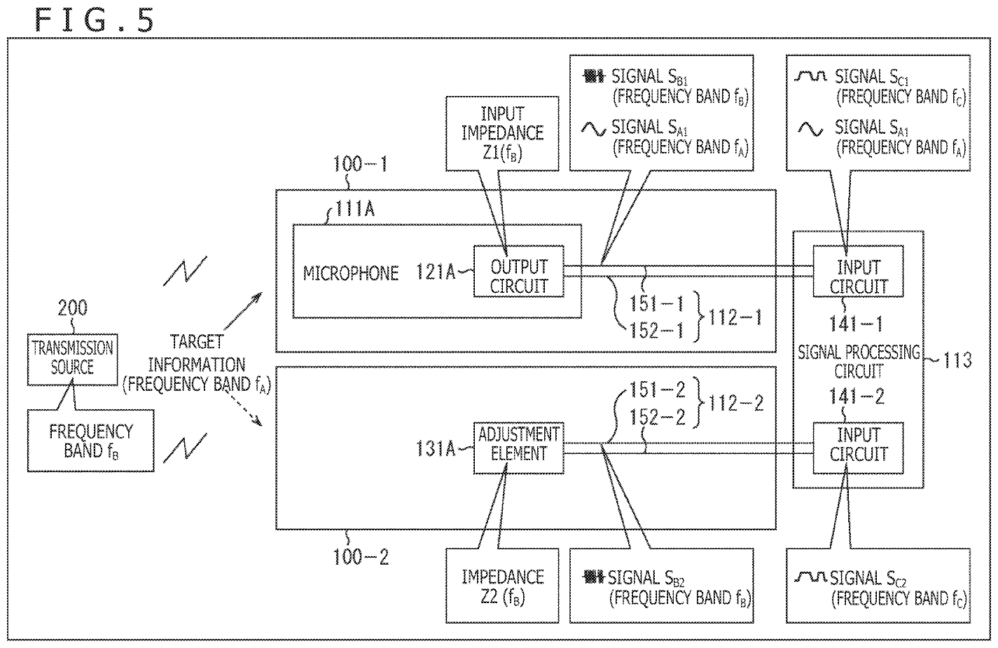

FIG. 5 is a diagram illustrating a second example of a configuration of the noise canceling system to which the present technique is applied.

The noise canceling system 10 can be provided, as the device 111, with any of various sensor devices, for example, a microphone, an illuminometer, a thermometer, a hygrometer, an angle sensor, an acceleration sensor, an image sensor, and the like. FIG. 5 illustrates such a configuration that a microphone 111A is provided as the device 111.

In FIG. 5, the input impedance Z1 (f_{B}) of (an output circuit 121A of) the microphone 111A in the frequency band f_{B} as viewed from the signal processing circuit 113 is computed, and an equivalent circuit (impedance Z2 (f_{B})) for the input impedance Z1 (f_{B}) is designed using an element (for example, an element such as a fixed resistor, a capacitor, or an inductor) not converting, into an electric signal, the voice band (frequency band f_{A}) corresponding to the target information.

The circuit network 100-2 including an adjustment element 131A with the impedance Z2 (f_{B}) designed as described above is disposed in proximity to the circuit network 100-1 including the microphone 111A to allow the (adjustment element 131A of the) circuit network 100-2 to detect the signal S_{B2} in the wireless communication (frequency band f_{B}) performed by the transmission source 200, that is, noise (signal similar to the signal S_{B1}) superimposed on a sound pickup signal (signal S_{A1}) picked up by the microphone 111A.

Accordingly, in the signal processing circuit 113, the signal with the signal S_{C1} superimposed on the signal S_{A1} is input to the input circuit 141-1, and the signal S_{C2} is input to the input circuit 141-2, in a case where the circuit networks lie within the reachable range of radio wave from the transmission source 200. Then, the signal processing circuit 113 can remove the signal S_{C1} superimposed on the signal S_{A1} obtained by the input circuit 141-1, by using the signal S_{C2} obtained by the input circuit 141-2.

For example, in a case where an external microphone is attached to a video camera to pick up an image, when the microphone approaches a transceiver built in the video camera, a radio wave from the transceiver causes noise to be superimposed on a sound pickup signal (voice signal) picked up by the microphone because a cable of the external microphone has a high degree of freedom in arrangement. Then, a high frequency component of the noise is attenuated due to the frequency characteristic of the microphone amplifier, but noise in an audible range remains and is consequently heard.

The present technique is employed in such a case. In a radio wave (frequency band f_{B}) from the transceiver of the video camera, the circuit network 100-2 including the adjustment element 131 with the impedance Z2 (f_{B}) corresponding to the input impedance Z1 (f_{B}) of the output circuit 121A of the microphone 111A is disposed in proximity to the circuit network 100-1 including the microphone 111A (the wiring 112-2 is disposed parallel to the wiring 112-1), to enable detection of noise in the same amount as that of noise caused by the radio wave, allowing removal of the noise.

As described above, in a case where the external microphone is used for the video camera, the noise sound caused by the radio wave from the internal or external transceiver can be reduced with the degree of freedom of the cable ensured. Note that the noise in this case may be caused by, instead of the radio wave from the transceiver built in the video camera, a radio wave from, for example, (a transceiver of) external equipment such as another camera or a smartphone.

### (Third Example of Configuration of Present Technique)

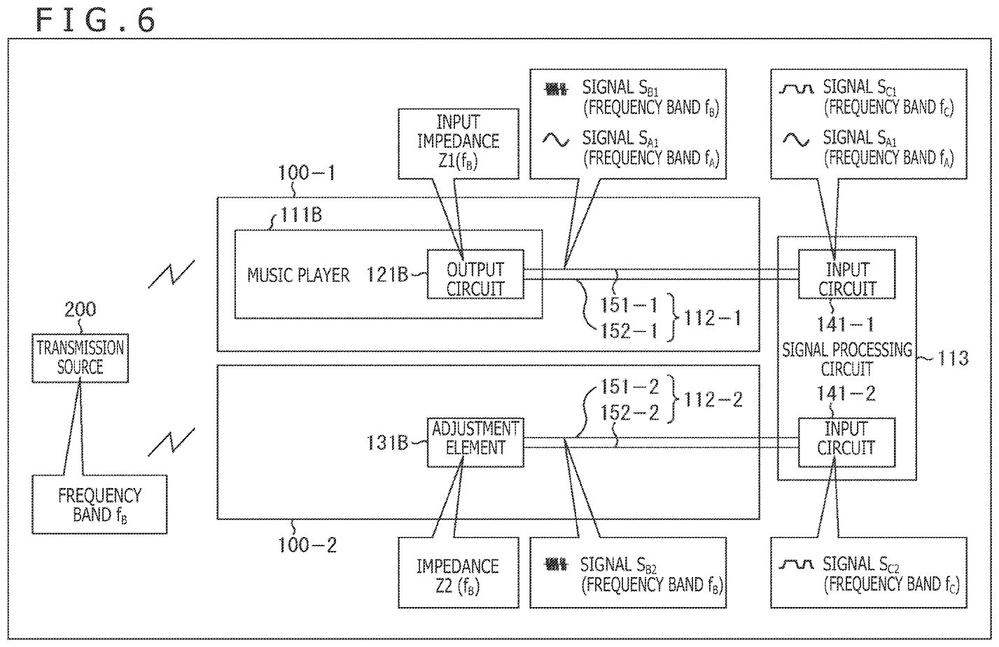

FIG. 6 is a diagram illustrating a third example of a configuration of the noise canceling system to which present technique is applied.

The noise canceling system 10 can be provided, as the device 111, with a circuit (analog output circuit) outputting analog signals for voice, temperature, humidity, angle information, acceleration information, imaging information, and the like, for example. FIG. 6 illustrates a configuration in a case where a music player 111B is provided as the device 111.

In FIG. 6, the input impedance Z1 (f_{B}) of (an output circuit 121B of) the music player 111B in the frequency band f_{B} as viewed from the signal processing circuit 113 is computed, and an equivalent circuit (impedance Z2 (f_{B})) for the input impedance Z1 (f_{B}) is designed using, for example, an element such as a fixed resistor, a capacitor, or an inductor.

The circuit network 100-2 including an adjustment element 131B with the impedance Z2 (f_{B}) designed as described above is disposed in proximity to the circuit network 100-1 including the music player 111B, to allow the (adjustment element 131B of the) circuit network 100-2 to detect the signal S_{B2} in the wireless communication (frequency band f_{B}) performed by the transmission source 200, that is, noise (signal similar to the signal S_{B1}) superimposed on an audio signal (signal S_{A1}) output from the music player 111B.

Accordingly, in the signal processing circuit 113, the signal with the signal S_{C1} superimposed on the signal S_{A1} is input to the input circuit 141-1, and the signal S_{C2} is input to the input circuit 141-2, in a case where the circuit networks lie within the reachable range of radio wave from the transmission source 200. Then, the signal processing circuit 113 can remove the signal S_{C1} superimposed on the signal S_{A1} obtained by the input circuit 141-1, by using the signal S_{C2} obtained by the input circuit 141-2.

### (Fourth Example of Configuration of Present Technique)

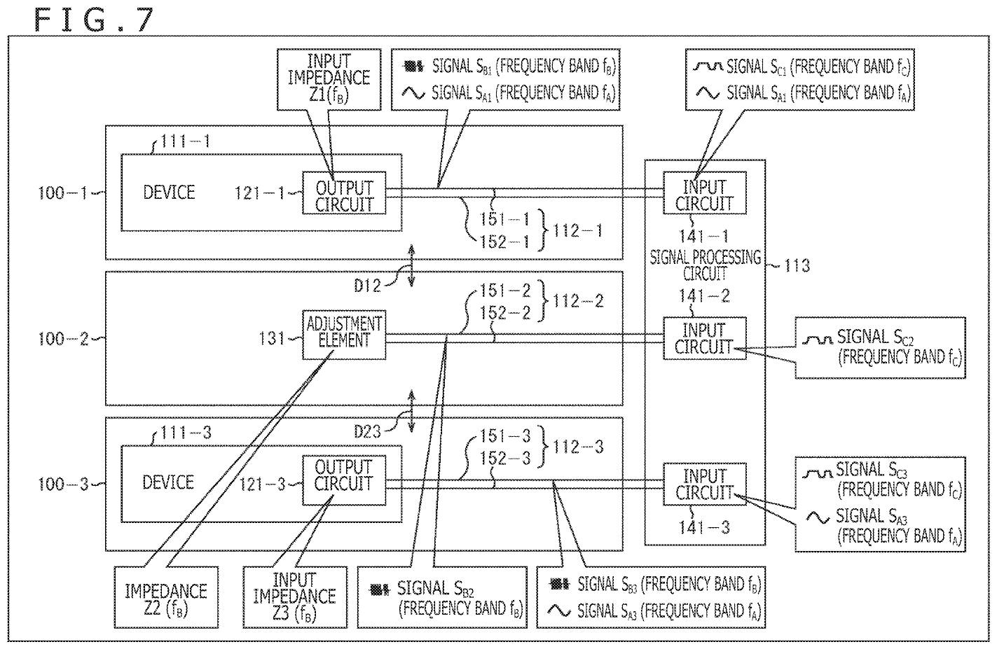

FIG. 7 is a diagram illustrating a fourth example of a configuration of the noise canceling system to which the present technique is applied.

The noise canceling system 10 is provided with a plurality of the devices 111, and in a case where the circuit network 100 including the device 111 is present in plural numbers, only one of the circuit networks 100 including the adjustment element 131 can be provided depending on arrangement conditions. FIG. 7 illustrates such a configuration that, in a case where the circuit network 100 including the device 111 is provided in plural numbers, only one of the circuit networks 100 including the adjustment element 131 is provided.

In FIG. 7, the input impedance Z1 (f_{B}) of (an output circuit 121-1 of) a device 111-1 in the frequency band f_{B} as viewed from the signal processing circuit 113 is computed, and an equivalent circuit (impedance Z2 (f_{B})) for the input impedance Z1 (f_{B}) is designed using, for example, an element such as a fixed resistor, a capacitor, or an inductor.

The circuit network 100-2 including the adjustment element 131 with the impedance Z2 (f_{B}) designed as described above is disposed in proximity to the circuit network 100-1 including the device 111-1 (arrow D12 in the figure) to allow the (adjustment element 131 of the) circuit network 100-2 to detect noise superimposed on a signal (signal S_{A1}) output from the device 111-1.

Additionally, the circuit network 100-2 including the adjustment element 131 is disposed in proximity to a circuit network 100-3 including a device 111-3 (arrow D23 in the figure), to allow the (adjustment element 131 of the) circuit network 100-2 to detect noise superimposed on a signal (signal S_{A3}) output from the device 111-3.

For example, in a case where the device 111-1 and the device 111-3 correspond to input sections of a microphone including two input lines corresponding to a left channel (Lch) and a right channel (Rch), only one of the circuit networks 100, the circuit network 100-2 including the adjustment element 131, may be provided, compared to the circuit network 100-1 including the device 111-1 for the left channel (Lch) and the circuit network 100-3 including the device 111-3 for the right channel (Rch).

Accordingly, in the signal processing circuit 113, the signal with the signal S_{C1} superimposed on the signal S_{A1} is input to the input circuit 141-1, and the signal S_{C2} is input to the input circuit 141-2. Then, the signal processing circuit 113 can remove the signal S_{C1} superimposed on the signal S_{A1} obtained by the input circuit 141-1, by using the signal S_{C2} obtained by the input circuit 141-2.

Furthermore, in the signal processing circuit 113, the signal with the signal S_{C3} superimposed on the signal S_{A3} is input to the input circuit 141-3. Then, the signal processing circuit 113 can remove a signal S_{C3} superimposed on the signal S_{A3} obtained by the input circuit 141-3, by using the signal S_{C2} obtained by the input circuit 141-2.

Note that FIG. 7 illustrates the configuration in which, compared to the circuit networks 100-1 and 100-3 respectively including the devices 111-1 and 111-3, only one of the circuit networks 100, the circuit network 100-2 including the adjustment element 131, is provided, but the number of circuit networks 100 including the different devices 111 is not limited to two, and three or more circuit networks 100 may include the different devices 111. In short, it is sufficient that the number of circuit networks 100 including the adjustment element 131 is smaller than the number of circuit networks 100 including the different devices 111, and the number of circuit networks 100 is optional.

As described above, according to the present technique, the adjustment element 131 designed under the predetermined conditions for the circuit network 100 is provided to enable removal of only the signal (noise) induced by a radio wave when the signal (noise) induced by the radio wave is superimposed on an analog signal. As a result, the noise induced by the radio wave can be reliably removed.

In particular, IoT devices are assumed to generally deal with signals ranging from high-frequency radio signals to low-frequency analog signals. For example, a certain sensor is used to acquire information from the outside world (for example, voice), and the information is caused to be transmitted to the signal processing circuit in the IoT device, or in contrast, information (for example, voice) resulting from signal processing executed by the signal processing circuit in the IoT device is transmitted to the outside world to be output.

Here, analog signals generally have low noise immunity, and thus, noise induced by a radio wave is non-negligible for these signals. For example, in the IoT device, when analog signal information is transmitted, longer wiring (signal line) of the IoT device leads to more susceptibility to the noise caused by the radio wave. Meanwhile, the noise induced by the radio wave may be generated due to not only the wireless communication function of the IoT device itself, but also wireless communication performed by other surrounding equipment.

For such IoT devices as well, application of the present technique allows only the signal (noise) induced by a radio wave to be similarly removed when the signal (noise) induced by the radio wave is superimposed on an analog signal.

### <2. Modified Example>

In the above-described case, the noise superimposed on the analog signal is removed. However, noise superimposed on a digital signal can similarly be removed.

For example, in a case where, in the circuit network 100-1 (FIG. 4), an AD conversion is used to convert an analog signal into a digital signal, the adjustment element 131 may be used to make the input impedance Z1 in an analog circuit equivalent to the impedance Z2. Additionally, for example, in a case where, in the device 111, an AD conversion is used to convert an analog signal into a digital signal, noise induced on the digital signal (frequency band f_{A}) by a radio wave can be removed depending on the conditions.

Additionally, in the above description, the adjustment element 131 includes a fixed resistor, a capacitor, an inductor, or the like. However, the adjustment element 131 may be configured using a variable element (for example, a variable resistor, capacitor, or the like). With the configuration that the adjustment element 131 includes a variable element, for example, the user can set (adjust) the level of noise detection to an optional level.

Note that, in the embodiment of the present technique, the wireless communication (frequency band f_{B}) performed by the transmission source 200 includes wireless communication in accordance with any of various communication schemes, for example, wireless LAN (Local Area Network) (Wi-Fi (registered trademark)), Bluetooth (registered trademark), mobile communication (for example, LTE-Advanced, 5G (5th Generation), Wideband CDMA (Code Division Multiple Access), GSM (registered trademark) (Global System for Mobile Communications), EDGE (Enhanced Data GSM (registered trademark) Environment), and the like), NFC (Near Field Communication), RFID (Radio Frequency Identifier), and the like.

Furthermore, as is the case with wireless LAN and the like as described above, an RF noise signal is assumed to be induced to the input signal by, for example, radio waves utilized for television broadcasting such as UHF (Ultra High Frequency) and VHF (Very High Frequency), FM broadcasting, and the like, and by microwaves from a microwave oven, and the present technique is effective for those radio waves.

Additionally, the configuration for removing noise (RF noise signal) superimposed on an analog signal or a digital signal to be transmitted via the wiring 112-1 has been described above. In this regard, the analog signal or the digital signal is assumed to be a signal corresponding to voice, video content, or various kinds of other data, for example.

### <3. Configuration of Computer>

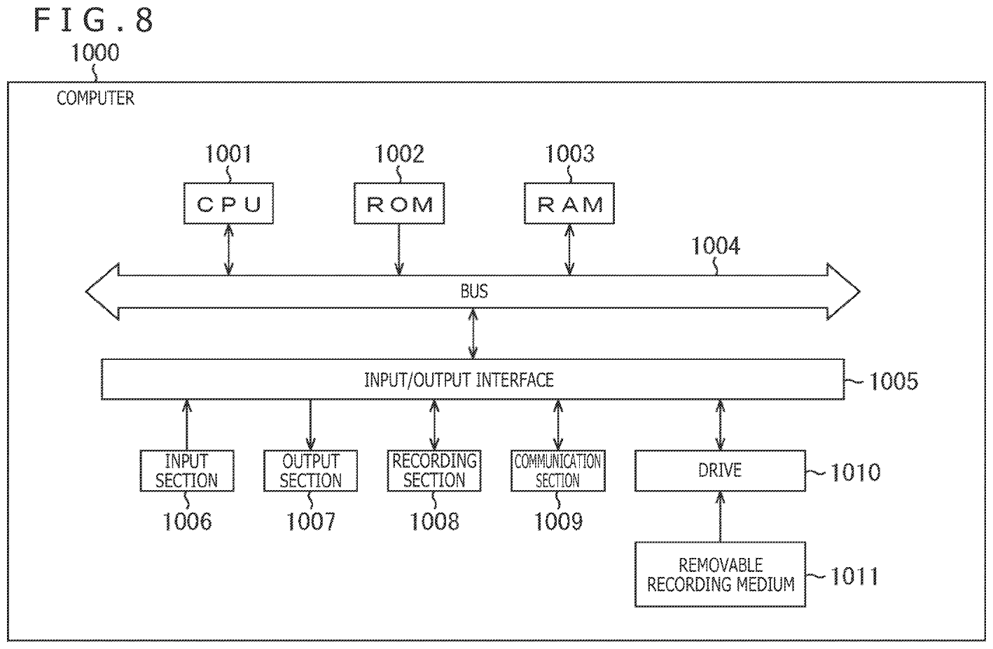

The series of steps of processing described above (for example, the noise removal processing to be executed by the signal processing circuit 113) can be executed by hardware or by software. In a case where the series of steps of processing is executed by software, a program included in the software is installed in a computer of an apparatus. FIG. 8 is a block diagram illustrating a configuration example of hardware of a computer executing the above-described series of steps of processing by a program.

In a computer 1000, a CPU (Central Processing Unit) 1001, a ROM (Read Only Memory) 1002, and a RAM (Random Access Memory) 1003 are connected together by a bus 1004. An input/output interface 1005 is further connected to the bus 1004. An input section 1006, an output section 1007, a recording section 1008, a communication section 1009, and a drive 1010 are connected to the input/output interface 1005.

The input section 1006 includes a microphone, a keyboard, a mouse, and the like. The output section 1007 includes a speaker, a display, and the like. The recording section 1008 includes a hard disk, a nonvolatile memory, and the like. The communication section 1009 includes a network interface and the like. The drive 1010 drives a removable recording medium 1011 such as a magnetic disk, an optical disc, a magneto-optical disc, or a semiconductor memory.

In the computer 1000 configured as described above, the CPU 1001 loads a program recorded in the ROM 1002 or the recording section 1008 into the RAM 1003 through the input/output interface 1005 and the bus 1004 and executes the program to execute the above-described series of steps of processing.

The program to be executed by the computer 1000 (CPU 1001) can be provided by being recorded in, for example, a removable recording medium 1011 used as a package medium or the like. Additionally, the program can be provided via a wired or wireless transmission medium such as a local area network, the Internet, and digital satellite broadcasting.

In the computer 1000, the program can be installed in the recording section 1008 through the input/output interface 1005 by loading the removable recording medium 1011 to the drive 1010. Additionally, the program can be received by the communication section 1009 via a wired or wireless transmission medium and installed in the recording section 1008. In addition, the program can be pre-installed in the ROM 1002 or the recording section 1008.

Note that the processing executed by the computer in accordance with the program also includes steps of processing executed in parallel or individually (for example, parallel processing or object-based processing). Additionally, the program may be processed by one computer (processor) or processed a plurality of computers in a distributed manner.

### <4. Applied Example>

The technique according to the present disclosure can be applied to various products. For example, the technique according to the present disclosure may be applied to an endoscopic surgery system.

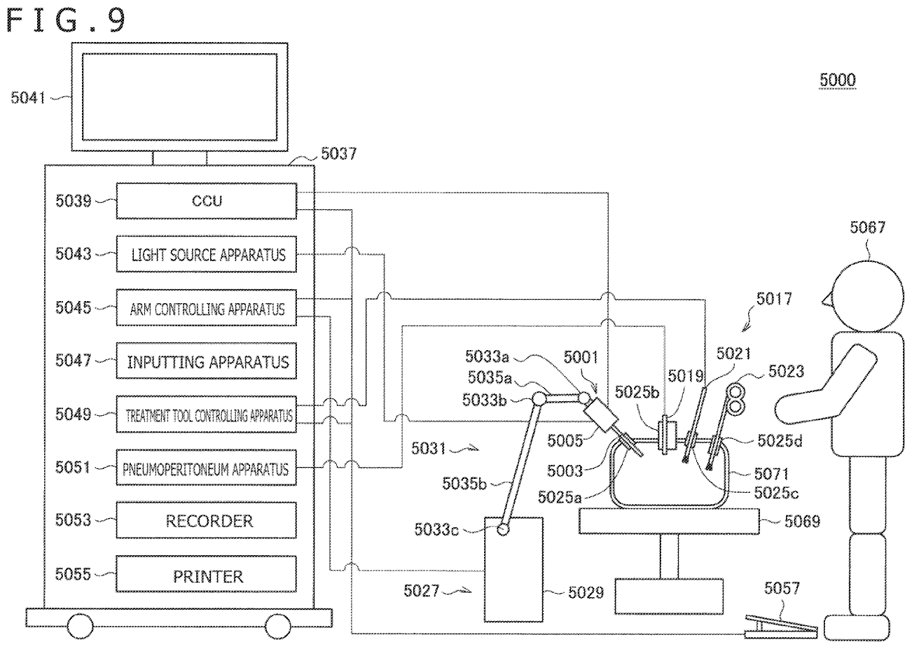

FIG. 9 is a view depicting an example of a schematic configuration of an endoscopic surgery system 5000 to which the technology according to an embodiment of the present disclosure can be applied. In FIG. 9, a state is illustrated in which a surgeon (medical doctor) 5067 is using the endoscopic surgery system 5000 to perform surgery for a patient 5071 on a patient bed 5069. As depicted, the endoscopic surgery system 5000 includes an endoscope 5001, other surgical tools 5017, a supporting arm apparatus 5027 which supports the endoscope 5001 thereon, and a cart 5037 on which various apparatus for endoscopic surgery are mounted.

In endoscopic surgery, in place of incision of the abdominal wall to perform laparotomy, a plurality of tubular aperture devices called trocars 5025a to 5025d are used to puncture the abdominal wall. Then, a lens barrel 5003 of the endoscope 5001 and the other surgical tools 5017 are inserted into body cavity of the patient 5071 through the trocars 5025a to 5025d. In the example depicted, as the other surgical tools 5017, a pneumoperitoneum tube 5019, an energy device 5021 and forceps 5023 are inserted into body cavity of the patient 5071. Further, the energy device 5021 is a treatment tool for performing incision and peeling of a tissue, sealing of a blood vessel or the like by high frequency current or ultrasonic vibration. However, the surgical tools 5017 depicted are mere examples at all, and as the surgical tools 5017, various surgical tools which are generally used in endoscopic surgery such as, for example, tweezers or a retractor may be used.

An image of a surgical region in a body cavity of the patient 5071 imaged by the endoscope 5001 is displayed on a display apparatus 5041. The surgeon 5067 would use the energy device 5021 or the forceps 5023 while watching the image of the surgical region displayed on the display apparatus 5041 on the real time basis to perform such treatment as, for example, resection of an affected area. It is to be noted that, though not depicted, the pneumoperitoneum tube 5019, the energy device 5021 and the forceps 5023 are supported by the surgeon 5067, an assistant or the like during surgery.

### (Supporting Arm Apparatus)

The supporting arm apparatus 5027 includes an arm unit 5031 extending from a base unit 5029. In the example depicted, the arm unit 5031 includes joint portions 5033a, 5033b and 5033c and links 5035a and 5035b and is driven under the control of an arm controlling apparatus 5045. The endoscope 5001 is supported by the arm unit 5031 such that the position and the posture of the endoscope 5001 are controlled. Consequently, stable fixation in position of the endoscope 5001 can be implemented.

### (Endoscope)

The endoscope 5001 includes the lens barrel 5003 which has a region of a predetermined length from a distal end thereof to be inserted into a body cavity of the patient 5071, and a camera head 5005 connected to a proximal end of the lens barrel 5003. In the example depicted, the endoscope 5001 is depicted as a rigid endoscope having the lens barrel 5003 of the hard type. However, the endoscope 5001 may otherwise be configured as a flexible endoscope having the lens barrel 5003 of the flexible type.

The lens barrel 5003 has, at a distal end thereof, an opening in which an objective lens is fitted. A light source apparatus 5043 is connected to the endoscope 5001 such that light generated by the light source apparatus 5043 is introduced to a distal end of the lens barrel by a light guide extending in the inside of the lens barrel 5003 and is irradiated toward an observation target in a body cavity of the patient 5071 through the objective lens. It is to be noted that the endoscope 5001 may be a forward-viewing endoscope or may be an oblique-viewing endoscope or a side-viewing endoscope.

An optical system and an image pickup element are provided in the inside of the camera head 5005 such that reflected light (observation light) from an observation target is condensed on the image pickup element by the optical system. The observation light is photo-electrically converted by the image pickup element to generate an electric signal corresponding to the observation light, namely, an image signal corresponding to an observation image. The image signal is transmitted as RAW data to a CCU 5039. It is to be noted that the camera head 5005 has a function incorporated therein for suitably driving the optical system of the camera head 5005 to adjust the magnification and the focal distance.

It is to be noted that, in order to establish compatibility with, for example, a stereoscopic vision (three dimensional (3D) display), a plurality of image pickup elements may be provided on the camera head 5005. In this case, a plurality of relay optical systems are provided in the inside of the lens barrel 5003 in order to guide observation light to each of the plurality of image pickup elements.

### (Various Apparatus Incorporated in Cart)

The CCU 5039 includes a central processing unit (CPU), a graphics processing unit (GPU) or the like and integrally controls operation of the endoscope 5001 and the display apparatus 5041. In particular, the CCU 5039 performs, for an image signal received from the camera head 5005, various image processes for displaying an image based on the image signal such as, for example, a development process (demosaic process). The CCU 5039 provides the image signal for which the image processes have been performed to the display apparatus 5041. Further, the CCU 5039 transmits a control signal to the camera head 5005 to control driving of the camera head 5005. The control signal may include information relating to an image pickup condition such as a magnification or a focal distance.

The display apparatus 5041 displays an image based on an image signal for which the image processes have been performed by the CCU 5039 under the control of the CCU 5039. If the endoscope 5001 is ready for imaging of a high resolution such as 4K (horizontal pixel number 3840×vertical pixel number 2160), 8K (horizontal pixel number 7680×vertical pixel number 4320) or the like and/or ready for 3D display, then a display apparatus by which corresponding display of the high resolution and/or 3D display are possible may be used as the display apparatus 5041. Where the apparatus is ready for imaging of a high resolution such as 4K or 8K, if the display apparatus used as the display apparatus 5041 has a size of equal to or not less than 55 inches, then a more immersive experience can be obtained. Further, a plurality of display apparatus 5041 having different resolutions and/or different sizes may be provided in accordance with purposes.

The light source apparatus 5043 includes a light source such as, for example, a light emitting diode (LED) and supplies irradiation light for imaging of a surgical region to the endoscope 5001.

The arm controlling apparatus 5045 includes a processor such as, for example, a CPU and operates in accordance with a predetermined program to control driving of the arm unit 5031 of the supporting arm apparatus 5027 in accordance with a predetermined controlling method.

An inputting apparatus 5047 is an input interface for the endoscopic surgery system 5000. A user can perform inputting of various kinds of information or instruction inputting to the endoscopic surgery system 5000 through the inputting apparatus 5047. For example, the user would input various kinds of information relating to surgery such as physical information of a patient, information regarding a surgical procedure of the surgery and so forth through the inputting apparatus 5047. Further, the user would input, for example, an instruction to drive the arm unit 5031, an instruction to change an image pickup condition (type of irradiation light, magnification, focal distance or the like) by the endoscope 5001, an instruction to drive the energy device 5021 or the like through the inputting apparatus 5047.

The type of the inputting apparatus 5047 is not limited and may be that of any one of various known inputting apparatus. As the inputting apparatus 5047, for example, a mouse, a keyboard, a touch panel, a switch, a foot switch 5057 and/or a lever or the like may be applied. Where a touch panel is used as the inputting apparatus 5047, it may be provided on the display face of the display apparatus 5041.

Otherwise, the inputting apparatus 5047 is a device to be mounted on a user such as, for example, a glasses type wearable device or a head mounted display (HMD), and various kinds of inputting are performed in response to a gesture or a line of sight of the user detected by any of the devices mentioned. Further, the inputting apparatus 5047 includes a camera which can detect a motion of a user, and various kinds of inputting are performed in response to a gesture or a line of sight of a user detected from a video imaged by the camera. Further, the inputting apparatus 5047 includes a microphone which can collect the voice of a user, and various kinds of inputting are performed by voice collected by the microphone. By configuring the inputting apparatus 5047 such that various kinds of information can be inputted in a contactless fashion in this manner, especially a user who belongs to a clean area (for example, the surgeon 5067) can operate an apparatus belonging to an unclean area in a contactless fashion. Further, since the user can operate an apparatus without releasing a possessed surgical tool from its hand, the convenience to the user is improved.

A treatment tool controlling apparatus 5049 controls driving of the energy device 5021 for cautery or incision of a tissue, sealing of a blood vessel or the like. A pneumoperitoneum apparatus 5051 feeds gas into a body cavity of the patient 5071 through the pneumoperitoneum tube 5019 to inflate the body cavity in order to secure the field of view of the endoscope 5001 and secure the working space for the surgeon. A recorder 5053 is an apparatus capable of recording various kinds of information relating to surgery. A printer 5055 is an apparatus capable of printing various kinds of information relating to surgery in various forms such as a text, an image or a graph.

In the following, especially a characteristic configuration of the endoscopic surgery system 5000 is described in more detail.

### (Supporting Arm Apparatus)

The supporting arm apparatus 5027 includes the base unit 5029 serving as a base, and the arm unit 5031 extending from the base unit 5029. In the example depicted, the arm unit 5031 includes the plurality of joint portions 5033a, 5033b and 5033c and the plurality of links 5035a and 5035b connected to each other by the joint portion 5033b. In FIG. 9, for simplified illustration, the configuration of the arm unit 5031 is depicted in a simplified form. Actually, the shape, number and arrangement of the joint portions 5033a to 5033c and the links 5035a and 5035b and the direction and so forth of axes of rotation of the joint portions 5033a to 5033c can be set suitably such that the arm unit 5031 has a desired degree of freedom. For example, the arm unit 5031 may preferably be configured such that it has a degree of freedom equal to or not less than 6 degrees of freedom. This makes it possible to move the endoscope 5001 freely within the movable range of the arm unit 5031. Consequently, it becomes possible to insert the lens barrel 5003 of the endoscope 5001 from a desired direction into a body cavity of the patient 5071.

An actuator is provided in each of the joint portions 5033a to 5033c, and the joint portions 5033a to 5033c are configured such that they are rotatable around predetermined axes of rotation thereof by driving of the respective actuators. The driving of the actuators is controlled by the arm controlling apparatus 5045 to control the rotational angle of each of the joint portions 5033a to 5033c thereby to control driving of the arm unit 5031. Consequently, control of the position and the posture of the endoscope 5001 can be implemented. Thereupon, the arm controlling apparatus 5045 can control driving of the arm unit 5031 by various known controlling methods such as force control or position control.

For example, if the surgeon 5067 suitably performs operation inputting through the inputting apparatus 5047 (including the foot switch 5057), then driving of the arm unit 5031 may be controlled suitably by the arm controlling apparatus 5045 in response to the operation input to control the position and the posture of the endoscope 5001. After the endoscope 5001 at the distal end of the arm unit 5031 is moved from an arbitrary position to a different arbitrary position by the control just described, the endoscope 5001 can be supported fixedly at the position after the movement. It is to be noted that the arm unit 5031 may be operated in a master-slave fashion. In this case, the arm unit 5031 may be remotely controlled by the user through the inputting apparatus 5047 which is placed at a place remote from the operating room.

Further, where force control is applied, the arm controlling apparatus 5045 may perform power-assisted control to drive the actuators of the joint portions 5033a to 5033c such that the arm unit 5031 may receive external force by the user and move smoothly following the external force. This makes it possible to move, when the user directly touches with and moves the arm unit 5031, the arm unit 5031 with comparatively weak force. Accordingly, it becomes possible for the user to move the endoscope 5001 more intuitively by a simpler and easier operation, and the convenience to the user can be improved.

Here, generally in endoscopic surgery, the endoscope 5001 is supported by a medical doctor called scopist. In contrast, where the supporting arm apparatus 5027 is used, the position of the endoscope 5001 can be fixed more certainly without hands, and therefore, an image of a surgical region can be obtained stably and surgery can be performed smoothly.

It is to be noted that the arm controlling apparatus 5045 may not necessarily be provided on the cart 5037. Further, the arm controlling apparatus 5045 may not necessarily be a single apparatus. For example, the arm controlling apparatus 5045 may be provided in each of the joint portions 5033a to 5033c of the arm unit 5031 of the supporting arm apparatus 5027 such that the plurality of arm controlling apparatus 5045 cooperate with each other to implement driving control of the arm unit 5031.

### (Light Source Apparatus)

The light source apparatus 5043 supplies irradiation light upon imaging of a surgical region to the endoscope 5001. The light source apparatus 5043 includes a white light source which includes, for example, an LED, a laser light source or a combination of them. In this case, where a white light source includes a combination of red, green, and blue (RGB) laser light sources, since the output intensity and the output timing can be controlled with a high degree of accuracy for each color (each wavelength), adjustment of the white balance of a picked up image can be performed by the light source apparatus 5043. Further, in this case, if laser beams from the respective RGB laser light sources are irradiated time-divisionally on an observation target and driving of the image pickup elements of the camera head 5005 is controlled in synchronism with the irradiation timings, then images individually corresponding to the R, G and B colors can be picked up time-divisionally. According to the method just described, a color image can be obtained even if a color filter is not provided for the image pickup element.

Further, driving of the light source apparatus 5043 may be controlled such that the intensity of light to be outputted is changed for each predetermined time. By controlling driving of the image pickup element of the camera head 5005 in synchronism with the timing of the change of the intensity of light to acquire images time-divisionally and synthesizing the images, an image of a high dynamic range free from underexposed blocked up shadows and overexposed highlights can be created.

Further, the light source apparatus 5043 may be configured to supply light of a predetermined wavelength band ready for special light observation. In special light observation, for example, by utilizing the wavelength dependency of absorption of light in a body tissue to irradiate light of a narrower wavelength band in comparison with irradiation light upon ordinary observation (namely, white light), narrow band light observation (narrow band imaging) of imaging a predetermined tissue such as a blood vessel of a superficial portion of the mucous membrane or the like in a high contrast is performed. Alternatively, in special light observation, fluorescent observation for obtaining an image from fluorescent light generated by irradiation of excitation light may be performed. In fluorescent observation, it is possible to perform observation of fluorescent light from a body tissue by irradiating excitation light on the body tissue (autofluorescence observation) or to obtain a fluorescent light image by locally injecting a reagent such as indocyanine green (ICG) into a body tissue and irradiating excitation light corresponding to a fluorescent light wavelength of the reagent upon the body tissue. The light source apparatus 5043 can be configured to supply such narrow-band light and/or excitation light suitable for special light observation as described above.

### (Camera Head and CCU)

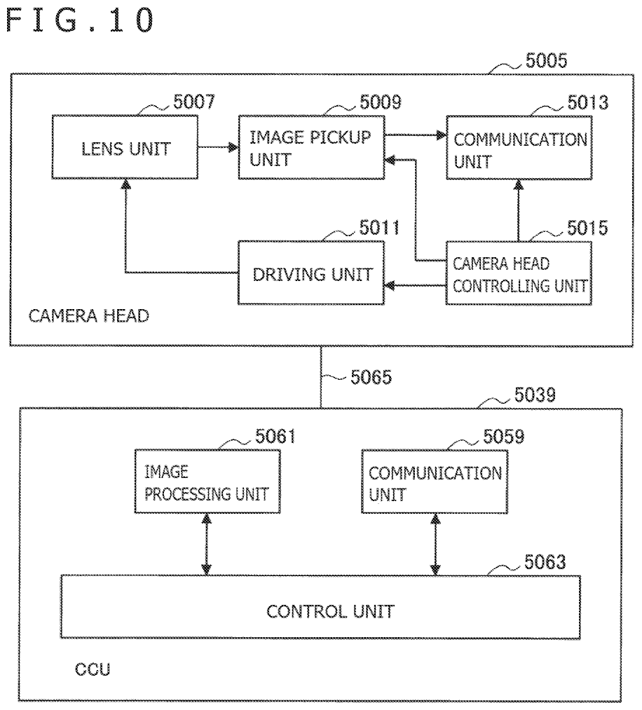

Functions of the camera head 5005 of the endoscope 5001 and the CCU 5039 are described in more detail with reference to FIG. 10. FIG. 10 is a block diagram depicting an example of a functional configuration of the camera head 5005 and the CCU 5039 depicted in FIG. 9.

Referring to FIG. 10, the camera head 5005 has, as functions thereof, a lens unit 5007, an image pickup unit 5009, a driving unit 5011, a communication unit 5013 and a camera head controlling unit 5015. Further, the CCU 5039 has, as functions thereof, a communication unit 5059, an image processing unit 5061 and a control unit 5063. The camera head 5005 and the CCU 5039 are connected to be bidirectionally communicable to each other by a transmission cable 5065.

First, a functional configuration of the camera head 5005 is described. The lens unit 5007 is an optical system provided at a connecting location of the camera head 5005 to the lens barrel 5003. Observation light taken in from a distal end of the lens barrel 5003 is introduced into the camera head 5005 and enters the lens unit 5007. The lens unit 5007 includes a combination of a plurality of lenses including a zoom lens and a focusing lens. The lens unit 5007 has optical properties adjusted such that the observation light is condensed on a light receiving face of the image pickup element of the image pickup unit 5009. Further, the zoom lens and the focusing lens are configured such that the positions thereof on their optical axis are movable for adjustment of the magnification and the focal point of a picked up image.

The image pickup unit 5009 includes an image pickup element and disposed at a succeeding stage to the lens unit 5007. Observation light having passed through the lens unit 5007 is condensed on the light receiving face of the image pickup element, and an image signal corresponding to the observation image is generated by photoelectric conversion of the image pickup element. The image signal generated by the image pickup unit 5009 is provided to the communication unit 5013.

As the image pickup element which is included by the image pickup unit 5009, an image sensor, for example, of the complementary metal oxide semiconductor (CMOS) type is used which has a Bayer array and is capable of picking up an image in color. It is to be noted that, as the image pickup element, an image pickup element may be used which is ready, for example, for imaging of an image of a high resolution equal to or not less than 4K. If an image of a surgical region is obtained in a high resolution, then the surgeon 5067 can comprehend a state of the surgical region in enhanced details and can proceed with the surgery more smoothly.

Further, the image pickup element which is included by the image pickup unit 5009 includes such that it has a pair of image pickup elements for acquiring image signals for the right eye and the left eye compatible with 3D display. Where 3D display is applied, the surgeon 5067 can comprehend the depth of a living body tissue in the surgical region more accurately. It is to be noted that, if the image pickup unit 5009 is configured as that of the multi-plate type, then a plurality of systems of lens units 5007 are provided corresponding to the individual image pickup elements of the image pickup unit 5009.

The image pickup unit 5009 may not necessarily be provided on the camera head 5005. For example, the image pickup unit 5009 may be provided just behind the objective lens in the inside of the lens barrel 5003.

The driving unit 5011 includes an actuator and moves the zoom lens and the focusing lens of the lens unit 5007 by a predetermined distance along the optical axis under the control of the camera head controlling unit 5015. Consequently, the magnification and the focal point of a picked up image by the image pickup unit 5009 can be adjusted suitably.

The communication unit 5013 includes a communication apparatus for transmitting and receiving various kinds of information to and from the CCU 5039. The communication unit 5013 transmits an image signal acquired from the image pickup unit 5009 as RAW data to the CCU 5039 through the transmission cable 5065. Thereupon, in order to display a picked up image of a surgical region in low latency, preferably the image signal is transmitted by optical communication. This is because, upon surgery, the surgeon 5067 performs surgery while observing the state of an affected area through a picked up image, it is demanded for a moving image of the surgical region to be displayed on the real time basis as far as possible in order to achieve surgery with a higher degree of safety and certainty. Where optical communication is applied, a photoelectric conversion module for converting an electric signal into an optical signal is provided in the communication unit 5013. After the image signal is converted into an optical signal by the photoelectric conversion module, it is transmitted to the CCU 5039 through the transmission cable 5065.

Further, the communication unit 5013 receives a control signal for controlling driving of the camera head 5005 from the CCU 5039. The control signal includes information relating to image pickup conditions such as, for example, information that a frame rate of a picked up image is designated, information that an exposure value upon image picking up is designated and/or information that a magnification and a focal point of a picked up image are designated. The communication unit 5013 provides the received control signal to the camera head controlling unit 5015. It is to be noted that also the control signal from the CCU 5039 may be transmitted by optical communication. In this case, a photoelectric conversion module for converting an optical signal into an electric signal is provided in the communication unit 5013. After the control signal is converted into an electric signal by the photoelectric conversion module, it is provided to the camera head controlling unit 5015.

It is to be noted that the image pickup conditions such as the frame rate, exposure value, magnification or focal point are set automatically by the control unit 5063 of the CCU 5039 on the basis of an acquired image signal. In other words, an auto exposure (AE) function, an auto focus (AF) function and an auto white balance (AWB) function are incorporated in the endoscope 5001.

The camera head controlling unit 5015 controls driving of the camera head 5005 on the basis of a control signal from the CCU 5039 received through the communication unit 5013. For example, the camera head controlling unit 5015 controls driving of the image pickup element of the image pickup unit 5009 on the basis of information that a frame rate of a picked up image is designated and/or information that an exposure value upon image picking up is designated. Further, for example, the camera head controlling unit 5015 controls the driving unit 5011 to suitably move the zoom lens and the focus lens of the lens unit 5007 on the basis of information that a magnification and a focal point of a picked up image are designated. The camera head controlling unit 5015 may further include a function for storing information for identifying the lens barrel 5003 and/or the camera head 5005.

It is to be noted that, by disposing the components such as the lens unit 5007 and the image pickup unit 5009 in a sealed structure having high airtightness and waterproof, the camera head 5005 can be provided with resistance to an autoclave sterilization process.

Now, a functional configuration of the CCU 5039 is described. The communication unit 5059 includes a communication apparatus for transmitting and receiving various kinds of information to and from the camera head 5005. The communication unit 5059 receives an image signal transmitted thereto from the camera head 5005 through the transmission cable 5065. Thereupon, the image signal may be transmitted preferably by optical communication as described above. In this case, for the compatibility with optical communication, the communication unit 5059 includes a photoelectric conversion module for converting an optical signal into an electric signal. The communication unit 5059 provides the image signal after conversion into an electric signal to the image processing unit 5061.

Further, the communication unit 5059 transmits, to the camera head 5005, a control signal for controlling driving of the camera head 5005. The control signal may also be transmitted by optical communication.

The image processing unit 5061 performs various image processes for an image signal in the form of RAW data transmitted thereto from the camera head 5005. The image processes include various known signal processes such as, for example, a development process, an image quality improving process (a bandwidth enhancement process, a super-resolution process, a noise reduction (NR) process and/or an image stabilization process) and/or an enlargement process (electronic zooming process). Further, the image processing unit 5061 performs a detection process for an image signal in order to perform AE, AF and AWB.

The image processing unit 5061 includes a processor such as a CPU or a GPU, and when the processor operates in accordance with a predetermined program, the image processes and the detection process described above can be performed. It is to be noted that, where the image processing unit 5061 includes a plurality of GPUs, the image processing unit 5061 suitably divides information relating to an image signal such that image processes are performed in parallel by the plurality of GPUs.

The control unit 5063 performs various kinds of control relating to image picking up of a surgical region by the endoscope 5001 and display of the picked up image. For example, the control unit 5063 generates a control signal for controlling driving of the camera head 5005. Thereupon, if image pickup conditions are inputted by the user, then the control unit 5063 generates a control signal on the basis of the input by the user.

Alternatively, where the endoscope 5001 has an AE function, an AF function and an AWB function incorporated therein, the control unit 5063 suitably calculates an optimum exposure value, focal distance and white balance in response to a result of a detection process by the image processing unit 5061 and generates a control signal.

Further, the control unit 5063 controls the display apparatus 5041 to display an image of a surgical region on the basis of an image signal for which image processes have been performed by the image processing unit 5061. Thereupon, the control unit 5063 recognizes various objects in the surgical region image using various image recognition technologies. For example, the control unit 5063 can recognize a surgical tool such as forceps, a particular living body region, bleeding, mist when the energy device 5021 is used and so forth by detecting the shape, color and so forth of edges of the objects included in the surgical region image. The control unit 5063 causes, when it controls the display unit 5041 to display a surgical region image, various kinds of surgery supporting information to be displayed in an overlapping manner with an image of the surgical region using a result of the recognition. Where surgery supporting information is displayed in an overlapping manner and presented to the surgeon 5067, the surgeon 5067 can proceed with the surgery more safety and certainty.

The transmission cable 5065 which connects the camera head 5005 and the CCU 5039 to each other is an electric signal cable ready for communication of an electric signal, an optical fiber ready for optical communication or a composite cable ready for both of electrical and optical communication.

Here, while, in the example depicted, communication is performed by wired communication using the transmission cable 5065, the communication between the camera head 5005 and the CCU 5039 may be performed otherwise by wireless communication. Where the communication between the camera head 5005 and the CCU 5039 is performed by wireless communication, there is no necessity to lay the transmission cable 5065 in the operating room. Therefore, such a situation that movement of medical staff in the operating room is disturbed by the transmission cable 5065 can be eliminated.

An example of the endoscopic surgery system 5000 to which the technology according to an embodiment of the present disclosure can be applied has been described above. It is to be noted here that, although the endoscopic surgery system 5000 has been described as an example, the system to which the technology according to an embodiment of the present disclosure can be applied is not limited to the example. For example, the technology according to an embodiment of the present disclosure may be applied to a flexible endoscopic system for inspection or a microscopic surgery system.

The technique according to the present disclosure may suitably be applied to the portion of the transmission cable 5065 connecting the camera head 5005 and the CCU 5039 among the configurations describe above. Specifically, for example, it can be considered that the camera head 5005 corresponds to the cable apparatus 11, that the CCU 5039 corresponds to the noise canceling apparatus 12, and that the transmission cable 5065 corresponds to the cable including the wiring 112-1 and the wiring 112-2. Additionally, in the camera head 5005, the image pickup unit 5009 or the like corresponds to the device 111, and in addition to the configuration illustrated in FIG. 10, the adjustment element 131 connected to the wiring 112-2 is further provided. In other words, in the endoscopic surgery system 5000, also when an analog video signal is transmitted through the transmission cable 5065, noise (RF noise signal) can be removed in a similar method to the above-described method for voice signals (sound pickup signals).

As described above, by applying the technique according to the present disclosure to the portion of the transmission cable 5065 connecting the camera head 5005 and the CCU 5039, for example, noise caused by a radio wave from an external transceiver can be reduced, allowing clearer images of the surgical region to be obtained. Thus, the surgery can be executed more safely and reliably.

Note that the embodiment of the present technique is not limited to the above-described embodiment and that various changes may be made without departing from the spirits of the present technique.

Additionally, the present technique can have the following configuration.

(1)

A cable apparatus including:

wiring for input which is electrically connected to a device and through which an input signal and an RF noise signal induced are transmitted, and

wiring for noise detection which is electrically connected to an adjustment element enabled to be adjusted to an impedance corresponding to an input impedance of an output circuit of the device and in which the RF noise signal is induced.

(2)

The cable apparatus according to (1) described above, in which

a first signal in a first frequency band output from the device and a second signal in a second frequency band induced by a radio wave are transmitted together to the wiring for input, and

the first signal in the first frequency band is not transmitted to the wiring for noise detection, and the second signal in the second frequency band induced by the radio wave is transmitted to the wiring for noise detection.

(3)

The cable apparatus according to (2) described above, in which

the first signal and the second signal are transmitted to the wiring for input in a case where the wiring for input is located within a reachable range of the radio wave from a transmission source for the radio wave, and

the first signal is not transmitted to the wiring for noise detection and the second signal is transmitted to the wiring for noise detection in a case where the wiring for noise detection is located within the reachable range of the radio wave.

(4)

The cable apparatus according to (2) or (3) described above, in which

the adjustment element is configured to be adjusted to the impedance such that a first circuit network including the device and the wiring for input and a second circuit network including the adjustment element and the wiring for noise detection have, in the second frequency band, an identical frequency characteristic or corresponding frequency characteristics.

(5)

The cable apparatus according to (2) or (3) described above, in which

in the second frequency band, a first period during which the radio wave is transmitted and a second period during which the radio wave is not transmitted are repeatedly present in a time domain,

a third frequency band of a third signal resulting from repetition of the first period and the second period includes a frequency band lower than the second frequency band and is included in the first frequency band,

a signal from the wiring for input includes a signal with the third signal superimposed on the first signal, and

a signal from the wiring for noise detection includes the third signal.

(6)

The cable apparatus according to any one of (1) to (5) described above, in which

the wiring for input and the wiring for noise detection are disposed in proximity to each other.

(7)

The cable apparatus according to (6) described above, in which

the wiring for input and the wiring for noise detection are disposed parallel to each other.

(8)

The cable apparatus according to (6) described above, in which

the wiring for input and the wiring for noise detection are combined into one cable.

(9)

The cable apparatus according to any one of (1) to (8) described above, in which

the wiring for input and the wiring for noise detection have a substantially identical length and substantially identical characteristics. (10)

The cable apparatus according to any one of (1) to (9) described above, in which

the input signal and the RF noise signal include analog signals.

(11)

The cable apparatus according to any one of (1) to (10) described above, in which

the input signal includes a voice signal.

(12)

The cable apparatus according to any one of (1) to (11) described above, in which

the device includes a sensor or an output apparatus which outputs an analog signal.

(13)

The cable apparatus according to any one of (1) to (12) described above, in which

the device includes a microphone.

(14)

The cable apparatus according to any one of (1) to (13) described above, in which

the adjustment element includes at least one of a resistor, a capacitor, or an inductor.

(15)

The cable apparatus according to (4) described above, in which

in a case where each of a plurality of the first circuit networks is provided with a different device, the single second circuit network is provided for the plurality of the first circuit networks.

(16)

The cable apparatus according to any one of (1) to (15) described above, further including:

the device; and

the adjustment element.

(17)

A noise canceling apparatus including:

a signal processing section configured to remove an RF noise signal to an input signal transmitted through wiring for input electrically connected to a device, using an RF noise signal induced in wiring for noise detection electrically connected to an adjustment element enabled to be adjusted to an impedance corresponding to an input impedance of an output circuit of the device.

(18)

The noise canceling apparatus according to (17) described above, in which

a first signal in a first frequency band output from the device and a second signal in a second frequency band induced by a radio wave are transmitted together to the wiring for input, and

the first signal in the first frequency band is not transmitted to the wiring for noise detection, and the second signal in the second frequency band induced by the radio wave is transmitted to the wiring for noise detection.

(19)

The noise canceling apparatus according to (18) described above, in which

the first signal and the second signal are transmitted to the wiring for input in a case where the wiring for input is located within a reachable range of the radio wave from a transmission source for the radio wave, and

the first signal is not transmitted to the wiring for noise detection and the second signal is transmitted to the wiring for noise detection in a case where the wiring for noise detection is located within the reachable range of the radio wave.

(20)

The noise canceling apparatus according to (18) or (19) described above, in which

the adjustment element is configured to be adjusted to the impedance such that a first circuit network including the device and the wiring for input and a second circuit network including the adjustment element and the wiring for noise detection have, in the second frequency band, an identical frequency characteristic or corresponding frequency characteristics

(21)

The noise canceling apparatus according to (18) or (19) described above, in which

in the second frequency band, a first period during which the radio wave is transmitted and a second period during which the radio wave is not transmitted are repeatedly present in a time domain,

a third frequency band of a third signal resulting from repetition of the first period and the second period includes a frequency band lower than the second frequency band and is included in the first frequency band,

a signal from the wiring for input includes a signal with the third signal superimposed on the first signal,

a signal from the wiring for noise detection includes the third signal, and

the signal processing section uses the third signal from the wiring for noise detection to remove the third signal superimposed on the first signal from the wiring for input.

(22)

The noise canceling apparatus according to any one of (17) to (21) described above, in which

the wiring for input and the wiring for noise detection are disposed in proximity to each other.

(23)

The noise canceling apparatus according to (22) described above, in which

the wiring for input and the wiring for noise detection are disposed parallel to each other.

(24)

The noise canceling apparatus according to (22) described above, in which

the wiring for input and the wiring for noise detection are combined into one cable.

(25)

The noise canceling apparatus according to any one of (17) to (24) described above, in which

the wiring for input and the wiring for noise detection have a substantially identical length and substantially identical characteristics.

(26)

The noise canceling apparatus according to any one of (17) to (25) described above, in which

the input signal and the RF noise signal include analog signals.

(27)

The noise canceling apparatus according to any one of (17) to (26) described above, in which

the input signal includes a voice signal.

(28)

The noise canceling apparatus according to any one of (17) to (27) described above, in which

the device includes a sensor or an output apparatus which outputs an analog signal.

(29)

The noise canceling apparatus according to any one of (17) to (28) described above, in which

the device includes a microphone. (30)

The noise canceling apparatus according to any one of (17) to (29) described above, in which

the adjustment element includes at least one of a resistor, a capacitor, or an inductor.

(31)

The noise canceling apparatus according to (20) described above, in which

in a case where each of a plurality of the first circuit networks is provided with a different device, the single second circuit network is provided for the plurality of the first circuit networks.

(32)

The noise canceling apparatus according to any one of (17) to (31) described above, further including:

the device;

the wiring for input;

the adjustment element; and

the wiring for noise detection.

(33)

A noise canceling method including:

by a noise canceling apparatus,

removing an RF noise signal to an input signal transmitted through wiring for input electrically connected to a device, using an RF noise signal induced in wiring for noise detection electrically connected to an adjustment element enabled to be adjusted to an impedance corresponding to an input impedance of an output circuit of the device.

### REFERENCE SIGNS LIST

10 Noise canceling system, 11 Cable apparatus, 12 Noise canceling apparatus, 100-1, 100-2, 100-3 Circuit network, 111, 111-1, 111-3 Device, 111A Microphone, 111B Music player, 112-1, 112-2 Wiring, 113 Signal processing circuit, 121, 121-1, 121-3 Output circuit, 131, 131A, 131B Adjustment element, 141-1, 141-2, 141-3 Input circuit, 151-1, 151-2, 151-3 Signal line, 152-1, 152-2, 152-3 Ground line, 200 Transmission source, 1000 Computer, 1001 CPU

1. A cable apparatus comprising:
wiring for input which is electrically connected to a device and through which an input signal and an RF noise signal induced are transmitted, and
wiring for noise detection which is electrically connected to an adjustment element enabled to be adjusted to an impedance corresponding to an input impedance of an output circuit of the device and in which the RF noise signal is induced.

2. The cable apparatus according to claim 1, wherein
a first signal in a first frequency band output from the device and a second signal in a second frequency band induced by a radio wave are transmitted together to the wiring for input, and
the first signal in the first frequency band is not transmitted to the wiring for noise detection, and the second signal in the second frequency band induced by the radio wave is transmitted to the wiring for noise detection.

3. The cable apparatus according to claim 2, wherein
the first signal and the second signal are transmitted to the wiring for input in a case where the wiring for input is located within a reachable range of the radio wave from a transmission source for the radio wave, and
the first signal is not transmitted to the wiring for noise detection and the second signal is transmitted to the wiring for noise detection in a case where the wiring for noise detection is located within the reachable range of the radio wave.

4. The cable apparatus according to claim 2, wherein
the adjustment element is configured to be adjusted to the impedance such that a first circuit network including the device and the wiring for input and a second circuit network including the adjustment element and the wiring for noise detection have, in the second frequency band, an identical frequency characteristic or corresponding frequency characteristics.

5. The cable apparatus according to claim 2, wherein
in the second frequency band, a first period during which the radio wave is transmitted and a second period during which the radio wave is not transmitted are repeatedly present in a time domain,
a third frequency band of a third signal resulting from repetition of the first period and the second period includes a frequency band lower than the second frequency band and is included in the first frequency band,
a signal from the wiring for input includes a signal with the third signal superimposed on the first signal, and
a signal from the wiring for noise detection includes the third signal.

6. The cable apparatus according to claim 1, wherein
the wiring for input and the wiring for noise detection are disposed in proximity to each other.

7. The cable apparatus according to claim 6, wherein
the wiring for input and the wiring for noise detection are disposed parallel to each other.

8. The cable apparatus according to claim 6, wherein
the wiring for input and the wiring for noise detection are combined into one cable.

9. The cable apparatus according to claim 1, wherein
the wiring for input and the wiring for noise detection have a substantially identical length and substantially identical characteristics.

10. The cable apparatus according to claim 1, wherein
the input signal and the RF noise signal include analog signals.

11. The cable apparatus according to claim 10, wherein
the input signal includes a voice signal.

12. The cable apparatus according to claim 1, wherein
the device includes a sensor or an output apparatus which outputs an analog signal.

13. The cable apparatus according to claim 12, wherein
the device includes a microphone.

14. The cable apparatus according to claim 1, wherein
the adjustment element includes at least one of a resistor, a capacitor, or an inductor.

15. The cable apparatus according to claim 4, wherein
in a case where each of a plurality of the first circuit networks is provided with a different device, the single second circuit network is provided for the plurality of the first circuit networks.

16. The cable apparatus according to claim 1, further comprising:
the device; and
the adjustment element.

17. A noise canceling apparatus comprising:
a signal processing section configured to remove an RF noise signal to an input signal transmitted through wiring for input electrically connected to a device, using an RF noise signal induced in wiring for noise detection electrically connected to an adjustment element enabled to be adjusted to an impedance corresponding to an input impedance of an output circuit of the device.

18. The noise canceling apparatus according to claim 17, wherein
a first signal in a first frequency band output from the device and a second signal in a second frequency band induced by a radio wave are transmitted together to the wiring for input, and
the first signal in the first frequency band is not transmitted to the wiring for noise detection, and the second signal in the second frequency band induced by the radio wave is transmitted to the wiring for noise detection.

19. The noise canceling apparatus according to claim 18, wherein
the first signal and the second signal are transmitted to the wiring for input in a case where the wiring for input is located within a reachable range of the radio wave from a transmission source for the radio wave, and
the first signal is not transmitted to the wiring for noise detection and the second signal is transmitted to the wiring for noise detection in a case where the wiring for noise detection is located within the reachable range of the radio wave.

20. The noise canceling apparatus according to claim 18, wherein
the adjustment element is configured to be adjusted to the impedance such that a first circuit network including the device and the wiring for input and a second circuit network including the adjustment element and the wiring for noise detection have, in the second frequency band, an identical frequency characteristic or corresponding frequency characteristics.

21. The noise canceling apparatus according to claim 18, wherein
in the second frequency band, a first period during which the radio wave is transmitted and a second period during which the radio wave is not transmitted are repeatedly present in a time domain,
a third frequency band of a third signal resulting from repetition of the first period and the second period includes a frequency band lower than the second frequency band and is included in the first frequency band,
a signal from the wiring for input includes a signal with the third signal superimposed on the first signal,
a signal from the wiring for noise detection includes the third signal, and
the signal processing section uses the third signal from the wiring for noise detection to remove the third signal superimposed on the first signal from the wiring for input.

22. The noise canceling apparatus according to claim 17, wherein
the wiring for input and the wiring for noise detection are disposed in proximity to each other.

23. The noise canceling apparatus according to claim 22, wherein
the wiring for input and the wiring for noise detection are disposed parallel to each other.

24. The noise canceling apparatus according to claim 22, wherein
the wiring for input and the wiring for noise detection are combined into one cable.

25. The noise canceling apparatus according to claim 17, wherein
the wiring for input and the wiring for noise detection have a substantially identical length and substantially identical characteristics.

26. The noise canceling apparatus according to claim 17, wherein
the input signal and the RF noise signal include analog signals.

27. The noise canceling apparatus according to claim 26, wherein
the input signal includes a voice signal.

28. The noise canceling apparatus according to claim 17, wherein
the device includes a sensor or an output apparatus which outputs an analog signal.

29. The noise canceling apparatus according to claim 28, wherein
the device includes a microphone.

30. The noise canceling apparatus according to claim 17, wherein
the adjustment element includes at least one of a resistor, a capacitor, or an inductor.

31. The noise canceling apparatus according to claim 20, wherein
in a case where each of a plurality of the first circuit networks is provided with a different device, the single second circuit network is provided for the plurality of the first circuit networks.

32. The noise canceling apparatus according to claim 17, further comprising:
the device;
the wiring for input;
the adjustment element; and
the wiring for noise detection.

33. A noise canceling method comprising:
by a noise canceling apparatus,
removing an RF noise signal to an input signal transmitted through wiring for input electrically connected to a device, using an RF noise signal induced in wiring for noise detection electrically connected to an adjustment element enabled to be adjusted to an impedance corresponding to an input impedance of an output circuit of the device.
